(19) United States
(12) Patent Application Publication
(10) Pub. No.: US 2007/0181691 A1
(43) Pub. Date: Aug. 9, 2007

(54) System and method for information retrieval with barcode using digital image capture devices

(75) Inventor: Feng-Lin Chang, Taipei (TW)

Correspondence Address: BACON & THOMAS, PLLC, 625 SLATERS LANE, FOURTH FLOOR, ALEXANDRIA, VA, 22314, US

(73) Assignee: Simpleact Incorporated, Taipei (TW)

(21) Appl. No.: 11/350,030

(22) Filed: Feb. 9, 2006

(51) Int. Cl. G06K 7/10

(52) U.S. Cl. 235/462.41; 235/462.45

(57) ABSTRACT

The present invention discloses a system and method for information retrieval by decoding barcodes from images obtained using a mobile device or computer. The barcode image is obtained via a digital camera or web cam attached to the mobile device or computer. After the barcode image has been obtained, the image is decoded using decoder residing in the mobile device or computer. Information contained in the barcode is displayed on the screen of the mobile device or computer. Further action is carried out according to information extracted from the barcode. Another method to decode the obtained image is to transmit the image through HTTP protocol to a server for decoding and carrying out instruction contained in the barcode.

### FIELD OF THE INVENTION

The present invention relates to the field of information retrieval utilizing barcode and digital camera lens as assisting tools for mobile devices and computers. The present invention works by using mobile devices or computers with digital camera built in or attached to for imaging the barcode, then using the same devices or computers with decoder installed to decode the content of the barcode.

For devices unable to support decoder installation but with internet accessibility, an alternative method and system through http protocol to upload the obtained image to a server for decoding and processing are provided.

### BACKGROUND OF THE INVENTION

Traditionally, barcodes are used for inventory control purpose or point of sales automation. The utilization usually requires scanners manufactured for certain code types to perform the scanning mechanism to decode and match with connected database servers for pricing or other pre-determined tasks like warehouse stocking and inventory.

With the evolution of mobile devices and computers from a simple voice communication tool to multi-functioned personal assistant with imaging capability, nowadays mobile devices and computers can be camera, scanner, internet surfing tool, even play the role of direction guide for those equipped with GPS function. The improved mobile device capability significantly reduces difficulties used to prevent these devices from playing the role of decoder once they obtained the barcode image. Without being able to decode, mobile device users were not able to determine what the barcode is about right away and can only use the mobile device on hand as sender and receiver. Users need to wait for the decoded results being sent back using SMS or MMS message.

The difficult problems presented for previous versions of mobile devices in decoding barcode image are now easily overcome. Barcode decoding algorithms can now be implemented in most of the mobile devices. Earlier problems like lighting, barcode size, skew, lens focus, and resolution prohibited mobile devices from consistently capable of decoding barcode images are now easily handled by most of the low cost mobile devices. Hence the decoding process can be carried out using mobile devices or computers equipped with digital camera or web cam to grant users the instant feedback of the decoded results, to offer more options and more convenient barcode enabled benefits. On device decoding further offers mobile device users the benefit of a new way of retrieving and inputting data into the device. Mobile devices are usually small and not equipped with keyboards, making data input a challenging task using the tiny number only keypad. With barcode as input media and digital camera as inputting tool, mobile devices can easily scan in information encoded in barcodes within seconds. Language difference is not a problem to encoded information since the decoder can decode in any language information is encoded with, making the decoding capability universally usable.

### SUMMARY OF THE INVENTION

The present invention provides a system and method designed to quickly decode barcodes obtained via digital camera and processing according to decoded information. The invention empowers a user to use a cell phone or PDA equipped with a digital camera to scan barcodes (one dimensional and two dimensional) or any other supported codes. The image obtained with the digital camera of the mobile device/computer is decoded using the decoder residing on the mobile device/computer.

The decoder extracts the barcode information and process the instruction contained in the information. Mobile network or any internet connection (fixed line or wireless, depending on availability or device capability) are used to retrieve further information or execute instructions according to decoded information.

The system according to the present invention, the user launches the decoder on the mobile device/computer. The decoder utilizes the built in/attached digital camera to scan the barcode the user chooses by having the barcode image filling up about the center half of the decoder view screen. Once a clear barcode image view is obtained, the decoder signals by sound or message pop up then shows the decoded information for user to view and waits for the user to confirm to proceed for next step if any contained in the decoded information. For instance, the decoded information may contain website address for further information as the user's choice, or instruction for next step to carry out for the user in response to the decoded information.

The system according to the present invention, for devices unable to support decoder installation but with internet accessibility, the user can launch device internet browser to connect to the upload link for transmitting the captured barcode image to the server for decoding and carrying out instructions contained in the barcode, then having the information pushed back from the server through the browser using internet connection.

The purpose of the present invention is to provide a system and method to accurately and reliably decode barcodes using the built-in/attached digital camera, to show the information contained in the barcode on the screen of the mobile device/computer without having to connect to the network unless the user wishes to. The decoder is designed to function under the normal environment the user encounters daily without requiring special lighting or equipment enhancement besides the digital camera built in/attached to the commonly available mobile device/computer, without requiring specific handling techniques.

The intention of the present invention is to provide users with a system and method to decode barcodes quickly and accurately without having to wait for results or feedback, to be able to make decision based on the decoded information right away.

Another object of the present invention is to offer a method and system which is robust regardless of lighting, angling, focusing, or user handling conditions.

Another intention of the present invention is to provide a method and system for barcode decoding without having to incur any cost to the user unless the user wants to obtain additional information or proceed to next step beyond whatever decoded information contained in the barcode.

### BRIEF DESCRIPTION OF THE DRAWINGS

FIG. 1 depicts examples of various one dimensional and two dimensional barcodes which are capable of being decoded.

FIG. 2 depicts a flowchart showing the steps the decoder takes to decode barcode image the user chooses.

FIG. 3 depicts a flowchart showing the steps taken for devices to utilize internet access to upload barcode image for decoding.

FIG. 4 depicts the procedure the decoder takes to enhance the barcode image for decoding purpose.

### DETAILED DESCRIPTION OF THE PREFERRED EMBODIMENTS

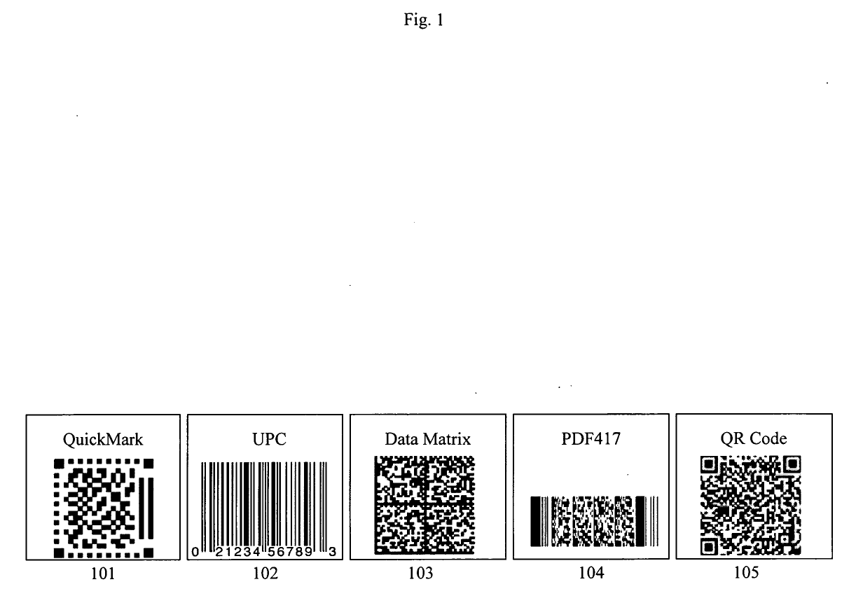

With reference to FIG. 1, showing several different one dimensional and two dimensional barcode formats. The decoder can be customized to be able to decode any of the standardized barcodes or any proprietary barcodes as long as the owner of rights to the proprietary barcodes grants legal use. Examples of standardized and proprietary barcode formats include, but not limited to, UPC, ISBN, EAN, Code 39, PDF 417, QR Code, Data Matrix, QuickMark. The decoder can further be customized as to be able to decode any particular barcode format only or be able to decode several different formats automatically. Hence, it's possible for the decoder to recognize all the available barcode formats, or just one format according to certain specifications for special purpose. Barcodes can be printed on flat surfaces such as paper or clothe, or painted on flat walls, billboards, even projected by using projector on above mentioned surfaces. Showing as image on computer screens, kiosk screens, or any LCD screens of various devices for use is also viable way of implementation.

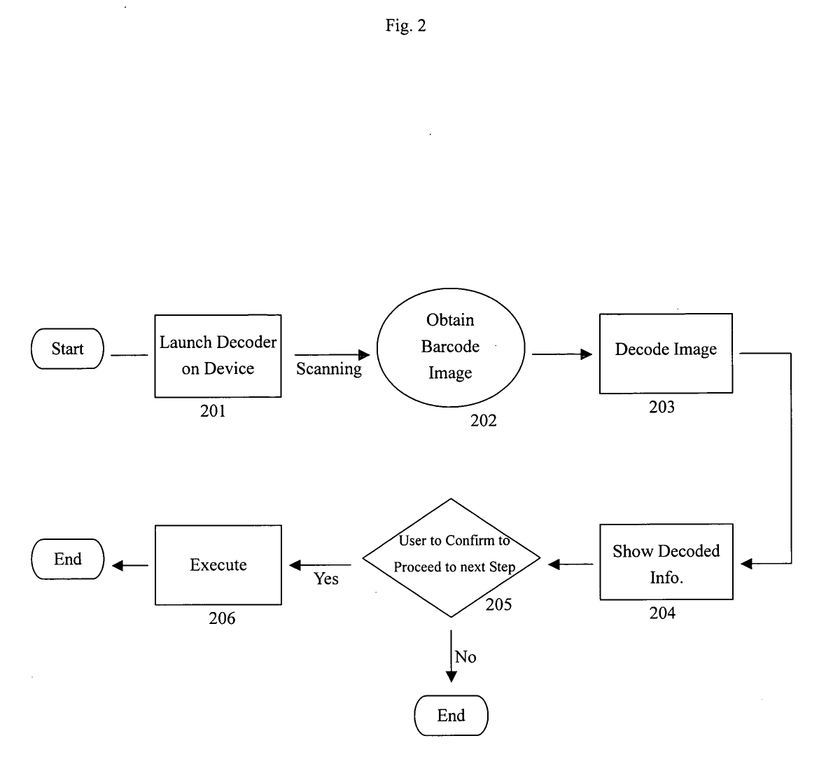

To learn what information is contained in the barcode seen by a user, FIG. 2 shows the procedures the decoder utilizes to extract information from the barcode seen. The user can initiate decoder on the mobile device he/she carries or the computer available, as in procedure 201. Mobile devices and computers with digital camera built in or attached to are commonly available today, like camera phone, PDA with digital camera, smart phone with digital camera, notebook computers with attached digital camera, even digital cameras with internet accessibility. The initiated decoder opens an imaging screen for the user to scan the barcode. No capturing action required from the digital camera for decoding purpose, the user only needs to move the mobile device so the barcode image would fill the center half of the screen, without specific requirement on handling techniques or particular angling, nor is particular direction of the barcode needed for procedure 202. Once the decoder obtains a decodable image, processing calculation automatically kicks in to extract the information contained in the barcode, as in 203, no action needed from the user to push any button or any other move yet at this step still. Extracted information is displayed on screen of the device/computer used for 204. Extracted information can be product information, address, direction, answers in response to questions raised, web page, inventory data, initiation of purchasing process, monetary payment process, or information with instruction for further actions requesting user consent, etc. The decoder extracts information locally without requiring additional resource. Some information extracted can contain instructions for further actions to take which would require user confirmation, as in 205. Without user consent, the flow ends. When user chooses to carry out the action, some may require internet connection to retrieve additional information or request authorization, like in payment process. The format for requesting and receiving is standard HTTP protocol. Other actions may simply require user's consent to save the information or carry out local function, like dialing a certain phone number. The flow is completed when all actions are executed according to user's consent. The internet connection can be achieved through PAC, GSM, 3G PHS, WAP, EDGE, GPRS, Wireless LAN, WiMAX, and any internet connection channel accessible using above mentioned mobile device or computer.

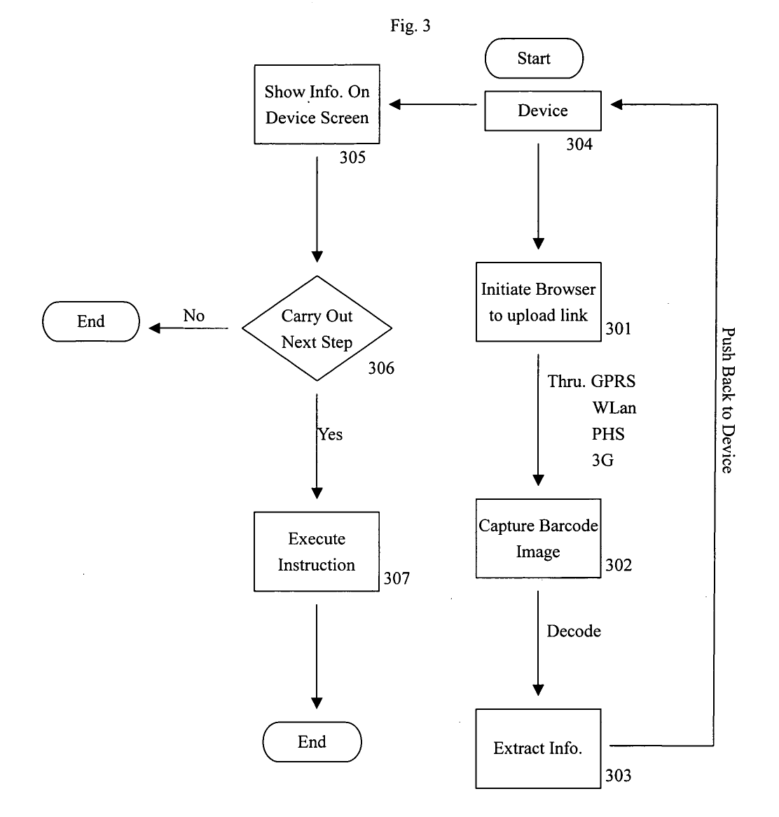

For those devices can not support the installation of the decoder, an alternative flow is utilized. Referring to FIG. 3, the device user launches the internet browser on the device/computer, uses the browser to connect to an upload link location where user can upload the barcode image for decoding, as in 301 and 302. The upload link location stores decoders and other tools needed to carry out the decoding process upon request. Once the information is extracted from the barcode image, the link pushes the information back to the device/computer through the same connection channel used for uploading the image for decoding. The pushed back information shows on the device screen for user to view. The user makes decision on further action to take according to the information shown, as in flow 306 and 307.

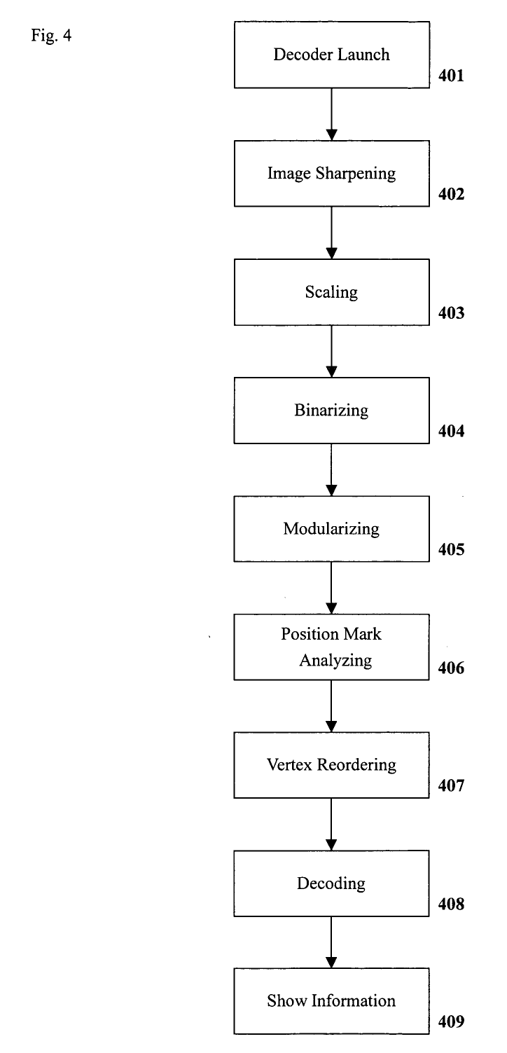

The detailed process the decoder goes through to complete the task of decoding is shown as FIG. 4. The decoder can reside in mobile devices or computers with digital cameras built in or attached to (used in 201, FIG. 2), or the decoder can be placed in any server to provide the service of upload decoding. The same process is undertaken regardless of where the decoder is performing its task. The decoder is designed to function in the daily environment a user encounters, which usually has great lighting variations, unstable scanning angles, shape distortion, even shadowing due to the position of the user when performing the scan. The decoder undergoes many steps to reinforce the image for decoding to overcome the possible poor lighting condition, low contrast, shape distortion, blurry pattern, or image noise.

The decoder decodes one dimensional and two dimensional barcodes with imaging resolution minimum requirement of 100 times 100. This requirement is below almost all commonly available mobile device equipped digital camera specifications. The decoder is launched upon user's initiation to decode a desired barcode, as in 401 . Once the barcode image is secured by the decoder by having the image filled the center half of the view screen, the decoder starts the sharpening algorithm to enhance the image for next step (step 402). Sharpening process clarifies the relative positions of pixels and modules in the image to each other, as well as contrast stretching to compensate for the sub-optimal lighting effect.

With sharpened image, step 403 works to adjust the image size to preset parameters, and calculate the relative size of the barcode for comparison to standards. Skew and yaw are adjusted at this stage.

The binarization process (step 404) converts colorful image or gray scale image into black and white or any other extreme contrast scales to prepare the image for further division.

The binarized barcode image is then divided into modules for identification purpose. The relative locations and distances of modules to each other in the barcode present the distinct features of various barcode formats, which are used as positioning marks to determine which algorithm to take for error correction and checksum calculation, shown as step 406.

With confirmation of position marks of the barcode, the vertices of the barcode are then locked as calculation basis according to the process algorithm available to the barcode format, as in step 407. Since the barcode image is omni-directional, without having to rotate the direction of the image for decoding, the vertices are used as reference to adjustment of deciphering information.

Decoding step (408) starts when all above mentioned processes are successfully completed to extract the information encoded in the barcode with accuracy. Various error correction and checksum algorithms are available for standard formats of barcodes; standard as well as proprietary algorithms are employed to ensure accuracy in the confirmation process. Any of the above steps not being able to complete with preset confidence level will cause the decoder to restart the flow until a successful completion reached.

Decoded information is displayed on the screen of user's mobile device/computer for user to view, and user can proceed to execute instructions contained in the information if user chooses to.

1. A method of information retrieval with barcode includes procedures of: decoding and analyzing a barcode by imaging a barcode with mobile device or computer equipped with a digital camera or web cam; decoding the barcode from above mentioned barcode image utilizing decoder residing in above mentioned mobile device or computer; processing above mentioned decoded barcode information to display content associated with above mentioned barcode; and carrying out instructions contained in the barcode via wireless network or any internet connection.

2. A method of information retrieval with barcode according to claim 1, wherein decoding of above mentioned barcode image by above mentioned mobile device or computer includes procedures of: adjusting above mentioned barcode image to sharpen; scaling above mentioned barcode image; binarizinging above mentioned barcode image; modularizing above mentioned barcode image; position analyzing above mentioned barcode image; and vertex reordering above mentioned barcode image.

3. A method of information retrieval with barcode according to claim 1, wherein decoding of above mentioned barcode includes the steps of: locating the positioning marks in above mentioned barcode image; choosing decoding procedure according to position marks found; and decoding above mentioned barcode from above mentioned barcode image utilizing algorithms contained in the chosen decoding procedure.

4. A method of information retrieval with barcode according to claim 1, wherein above mentioned barcode is constructed from standardized barcode symbology libraries like UPC, ISBN, EAN, Code 128, PDF417, QR Code, Data Matrix, and other proprietary codes with grant of use from appropriate owners of right.

5. A method of information retrieval with barcode according to claim 3, wherein decoding above mentioned barcode from above mentioned barcode image utilizing above mentioned decoding procedure comprises the steps of: locating the positioning mark in above mentioned barcode image; calculating the positioning marks within above mentioned barcode image; calculating the relative positions of modules contained in the above mentioned barcode image in reference to the positioning marks; and decoding contents from modules utilizing above mentioned decoding procedure.

6. A method of information retrieval with barcode according to claim 5, wherein modules from above mentioned barcode are units of pixels.

7. A method of information retrieval with barcode according to claim 5, wherein above mentioned steps of decoding above mentioned barcode from above mentioned barcode image utilizing above mentioned decoding procedure further include: confirming validity of decoded information utilizing error correction process and checksum verification.

8. A method of information retrieval with barcode according to claim 1, wherein above mentioned mobile device is a mobile handset, camera phone, smart phone, PDA, PDA phone, or laptop computer.

9. A method of information retrieval with barcode according to claim 1, wherein above mentioned barcode contains information or instruction for further actions to be proceeded.

10. A method of information retrieval with barcode according to claim 1, wherein contents transmitted back to mobile device or computer is further information in regard to decoded information from above mentioned barcode, data in response to the decoded information from above mentioned barcode, or response to steps taken according to decoded instructions from above mentioned barcode.

11. A method of information retrieval with barcode according to claim 1, wherein above mentioned decoded barcode information is transmitted via HTTP protocol.

12. A method of information retrieval with barcode according to claim 1, wherein above mentioned wireless network is PAC, GSM, 3G, PHS, WAP, EDGE, GPRS, Wireless LAN, WiMAX, and any internet connection channel accessible using above mentioned mobile device or computer.

13. A system for information retrieval with barcode comprises of: decodable barcode, mobile device equipped with digital camera or web cam for imaging above mentioned barcode; a wireless network; a internet connection; and decoder for decoding above mentioned barcode image to extract barcode information, carrying out instructions contained in the extracted barcode information via above mentioned wireless network, wherein content, data, or response is transmitted via HTTP protocol back to mobile device according to extracted information.

14. A system for information retrieval with barcode according to claim 13, wherein above mentioned decoder processes above mentioned barcode image by performing the steps of: adjusting above mentioned barcode image to sharpen;
scaling above mentioned barcode image; binarizinging above mentioned barcode image; modularizing above mentioned barcode image; position analyzing above mentioned barcode image; and vertex reordering above mentioned barcode image; and calculating for error correction and validity of above mentioned barcode.

15. A system for information retrieval with barcode according to claim 13,wherein above mentioned decoding of above mentioned barcode by decoder on the mobile device or computer comprises the steps of: locating the positioning marks in above mentioned barcode image; choosing decoding procedure according to position marks found; and decoding above mentioned barcode from above mentioned barcode image utilizing algorithms contained in the chosen decoding procedure.

16. A system of information retrieval with barcode according to claim 13, wherein above mentioned barcode is constructed from standardized barcode symbology libraries like UPC, ISBN, EAN, Code 128, PDF417, QR Code, Data Matrix, and other proprietary codes with grant of use from appropriate owners of right.

17. A system of information retrieval with barcode according to claim 13, wherein above mentioned barcode containing information or instruction for further actions to be proceeded.

18. A system of information retrieval with barcode according to claim 13, wherein contents transmitted back to mobile device or computer is further information in regard to decoded information from above mentioned barcode, data in response to the decoded information from above mentioned barcode, or response to steps taken according to decoded instructions from above mentioned barcode.

19. A system of information retrieval with barcode according to claim 13, wherein above mentioned wireless network is PAC, GSM, 3G, PHS, WAP, EDGE, GPRS, Wireless LAN, WiMAX, and any internet connection channel accessible using above mentioned mobile device or computer.

20. A system of information retrieval with barcode according to claim 13, wherein above mentioned decoded barcode information is transmitted via HTTP protocol.

21. A method of information retrieval with barcode according to claim 1, wherein information extracted from above mentioned barcode using decoder on the mobile device or computer is transmitted to instructed destination contained in the decoded information via HTTP protocol.

22. A method of information retrieval with barcode according to claim 1, wherein contents transmitted back to mobile device or computer is further information in regard to decoded information from above mentioned barcode, data in response to the decoded information from above mentioned barcode, or response to steps taken according to decoded instructions from above mentioned barcode via HTTP protocol.

23. A method of information retrieval with barcode includes the steps of: capturing barcode image using mobile device or computer equipped with digital camera or web cam; transmitting captured barcode image through HTTP protocol to a server via wireless network or any internet connection; enhancing above mentioned barcode image with tools residing on the server; decoding the barcode image with tools on the server; processing information extracted from the barcode and carry out instructions contained in the barcode for further action;
transmitting above mentioned information and related content to the mobile device or computer via wireless network or any internet connection.

24. A method of information retrieval with barcode according to claim 23, wherein the barcode image enhancing procedures carried out by the above mentioned server include: adjusting above mentioned barcode image to sharpen; scaling above mentioned barcode image; binarizinging above mentioned barcode image;
modularizing above mentioned barcode image; position analyzing above mentioned barcode image; and vertex reordering above mentioned barcode image.

25. A method of information retrieval with barcode according to claim 23, wherein decoding of above mentioned barcode includes the steps of: locating the positioning marks in above mentioned barcode image; choosing decoding procedure according to position marks found; and decoding above mentioned barcode from above mentioned barcode image utilizing algorithms contained in the chosen decoding procedure.

26. A method of information retrieval with barcode according to claim 23, wherein above mentioned barcode is constructed from standardized barcode symbology libraries like UPC, ISBN, EAN, Code 128, PDF417, QR Code, Data Matrix, and other proprietary codes with grant of use from appropriate owners of right.

27. A method of information retrieval with barcode according to claim 25, wherein decoding above mentioned barcode from above mentioned barcode image utilizing above mentioned decoding procedure comprises the steps of: locating the positioning mark in above mentioned barcode image; calculating the positioning marks within above mentioned barcode image; calculating the relative positions of modules contained in the above mentioned barcode image in reference to the positioning marks; and decoding contents from modules utilizing above mentioned decoding procedure.

28. A method of information retrieval with barcode according to claim 27, wherein modules from above mentioned barcode are units of pixels.

29. A method of information retrieval with barcode according to claim 27, wherein above mentioned steps of decoding above mentioned barcode from above mentioned barcode image utilizing above mentioned decoding procedure further include: confirming validity of decoded information utilizing error correction process and checksum verification.

30. A method of information retrieval with barcode according to claim 23, wherein above mentioned mobile device is a mobile handset, camera phone, smart phone, PDA, PDA phone, notebook computer, or computer.

31. A method of information retrieval with barcode according to claim 23, wherein above mentioned decoded barcode information is transmitted via HTTP protocol.

32. A method of information retrieval with barcode according to claim 1, wherein above mentioned wireless network is PAC, GSM, 3G PHS, WAP, EDGE, GPRS, Wireless LAN, WiMAX, and any internet connection channel accessible using above mentioned mobile device or computer.

33. A method of information retrieval with barcode according to claim 23, wherein contents transmitted back to mobile device or computer is decoded information, further information in regard to decoded information from above mentioned barcode, data in response to the decoded information from above mentioned barcode, or response to steps taken according to decoded instructions from above mentioned barcode.
